(19) United States
(12) Patent Application Publication
(10) Pub. No.: US 2008/0240000 A1
(43) Pub. Date: Oct. 2, 2008

(54) SYSTEM AND METHOD FOR RADIO OPERATION IN UMTS BANDS I AND IV UTILIZING A SINGLE RECEIVING PORT

(76) Inventor: Phillip Clifford KIDD, Fuquay-Varina, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/692,320

(22) Filed: Mar. 28, 2007

(51) Int. Cl. H04L 5/14

(52) U.S. Cl. 370/275

(57) ABSTRACT

A portable electronic device comprises a multi-band wireless transceiver for communication with a remote device. The portable electronic device comprises a transceiver: i) generating a first band modulated carrier at a first transmitter port; ii) generating a second band modulated carrier at a second transmitter port; and iii) including a low noise amplifier receiving port. A front-end circuit couples the transceiver to an antenna. The front-end circuit includes a first band modulated carrier transmission signal path from the first transmitter port to the antenna comprising: i) a coupling of a first band modulated carrier from the first transmitter port of the transceiver to a low pass port of a diplexer; ii) the diplexer comprising a low pass filter coupling the first band modulated carrier from the low pass port of the diplexer to a common port of the diplexer; and iii) a coupling of the first band modulated carrier from the common port of the diplexer to the antenna. A second band modulated carrier transmission signal path from the second transmitter port to the antenna comprises: i) a coupling of the second band modulated carrier from the second transmitter port of the transceiver to a transmit port of a duplexer; ii) the duplexer comprising a low band pass filter coupling the second band modulated carrier from the transmit port of the duplexer to a common port of the duplexer; iii) a coupling of the second band modulated carrier from the common port of the duplexer to a high pass port of the diplexer; iv) the diplexer comprising a high pass filter coupling the second band modulated carrier from the high pass port of the diplexer to the common port of the diplexer; and v) a coupling of the second band modulated carrier from the common port of the diplexer to the antenna. A modulated carrier received signal path from the antenna to the receiving port comprises: i) a coupling of a modulated carrier from the antenna to the common port of the diplexer; ii) the high pass filter of the diplexer coupling the modulated carrier from the common port to the high pass port of the diplexer; iii) a coupling of the modulated carrier from the high pass port of the diplexer to the common port of the duplexer; iv) the duplexer comprising a high band pass filter coupling the modulated carrier from the common port of the duplexer to a receive port of the duplexer while attenuating the second band modulated carrier; and v) a coupling for the modulated carrier from the receive port of the duplexer to the receiving port of the transceiver.

### TECHNICAL FIELD OF THE INVENTION

The present invention relates to portable electronic devices and, in particular, to portable electronic devices with multi-band wireless communication capabilities.

### DESCRIPTION OF THE RELATED ART

The Universal Mobile Telecommunication System (UMTS) standards are evolving for what is known as third-generation (3G) telecommunication standards to replace GSM and other existing standards.

UMTS specifies eight frequency bands for wideband code division multiple access (WCDMA) communications. Each frequency band comprises: i) a transmit frequency band for transmission by a portable electronic device and reception by a network service provider access point (e.g. a tower); and ii) a receiving frequency band for transmission by the network service provider access point and reception by the portable electronic device.

UMTS Band I includes a transmit frequency band of 1,920 MHz to 1,980 MHz and a receiving frequency band of 2,110 MHz to 2,170 MHz. UMTS Band IV includes a transmit frequency band of 1,710 MHz to 1,755 MHz and a receiving frequency band of 2,110 MHz to 2,155 MHz. It is noted that UMTS Band I and UMTS Band IV utilize different transmitting frequency bands and an overlapping receiving frequency band.

One challenge facing portable electronic device providers is developing a strategy for implementing a multi-band RF front end for both UMTS Band I and UMTS Band IV using a common antenna. It has been proposed to use a triplexer as represented by triplexer 100 of FIG. 1. The triplexer 100 comprises two transmit ports 102 and 104 and a single receive port 106 for combining a UMTS Band I transmit carrier and a UMTS Band IV transmit carrier on a single antenna 108 while passing a 2.1 GHz received carrier to the receive port 106.

A problem with such a solution is that development of such a triplexer with appropriate attenuation for isolating each frequency band (e.g. 1,920 MHz to 1,980 MHz; 1,710 MHz to 1,755 MHz; and 2,110 MHz to 2,170 MHz) has not yet occurred and, if such a device is developed, its cost would likely be high.

What is needed is a portable electronic device which is capable of communicating utilizing UMTS Band I and UMTS Band IV using: i) a multi-band transceiver with a single low noise amplifier (LNA) port for receiving both UMTS Band I and UMTS Band IV signals within the overlapping frequency band; and ii) a front end circuit that does not suffer the disadvantages of the proposed solutions.

### SUMMARY

A first aspect of the present invention comprises a front-end circuit for a multi-band wireless transceiver. The front-end circuit comprises a diplexer with a common port to be coupled to an antenna. The diplexer includes a low pass filter coupling the common port to a lower band port and a high pass filter coupling the common port to a upper band port. The diplexer receives a first band modulated carrier signal from a first transmitter port of the transceiver at the lower band port. The first band modulated carrier is within a lower frequency band compatible with the low pass characteristics of the low pass filter of the diplexer.

A duplexer includes a common port coupled to the upper band port of the diplexer. The duplexer includes a low band pass filter coupling the common port to a transmitter port and a high band pass filter coupling the common port to a receive port while attenuating any signal from the transmitter port. The receive port is also to be coupled to a low noise amplifier receiving port of the transceiver. The duplexer receives, at the transmitter port, a second band modulated carrier from a second transmitter port of the transceiver.

In one embodiment, the front end circuit may further comprise a first surface acoustic wave (SAW) filter with an input coupled to the first transmitter port of the transceiver and an output coupled to an input port of a lower band power amplifier. The lower band power amplifier includes an output port coupled to the lower band port of the diplexer such that the first band modulated carrier transmission signal is coupled from the first transmitter port of the transceiver to the lower band port of the diplexer through the SAW filter and the lower band power amplifier.

In another embodiment, the front end circuit may further comprise a first SAW filter with an input coupled to the first transmitter port of the transceiver and an output coupled to an input port of a lower band power amplifier. The lower band power amplifier includes an output port coupled to an input port of a second SAW filter. The second SAW filter includes an output port coupled to the lower band port of the diplexer such that the first band modulated carrier transmission signal is coupled from the first transmitter port of the transceiver to the lower band port of the diplexer through the first SAW filter, the power amplifier, and the second SAW filter.

The low pass filter of the diplexer is configured to pass a frequency band between 1,710 MHz and 1,755 MHz. The high pass filter of the diplexer is configured to pass a frequency band between 1,920 MHz and 2,179 MHz. The low band pass filter of the duplexer is configured to pass a frequency band between 1,920 MHz and 1,980 MHz, And, the high band pass filter of the duplexer is configured to pass a frequency band between 2,110 MHz and 2,170 MHz.

A second aspect of the present invention also comprises a front-end circuit for a multi-band wireless transceiver. The front-end circuit of this second aspect comprises a first band modulated carrier transmission signal path from a first transmitter port of a transceiver to an antenna.

The first modulated carrier transmission signal path comprises: i) a coupling of a first band modulated carrier from the first transmitter port of the transceiver to a low pass port of a diplexer; ii) the diplexer comprising a low pass filter coupling the first band modulated carrier from the low pass port of the diplexer to a common port of the diplexer; and iii) a coupling of the first band modulated carrier from the common port of the diplexer to the antenna.

The front-end circuit further comprises a second band modulated carrier transmission signal path from a second transmitter port of the transceiver to the antenna. The second band modulated carrier transmission signal path comprises: i) a coupling of the second band modulated carrier from the second transmitter port of the transceiver to a transmit port of a duplexer; ii) the duplexer comprising a low band pass filter coupling the second band modulated carrier from the transmit port of the duplexer to a common port of the duplexer (while isolating the second band modulated carrier from a receive port of the duplexer); iii) a coupling of the second band modulated carrier from the common port of the duplexer to a high pass port of the diplexer; iv) the diplexer comprising a high pass filter coupling the second band modulated carrier from the high pass port of the diplexer to the common port of the diplexer; and v) a coupling of the second band modulated carrier from the common port of the diplexer to the antenna.

The front-end circuit further comprises a modulated carrier received signal path from the antenna to a low noise amplifier receiving port of the transceiver. The modulated carrier received signal path comprises: i) a coupling of a modulated carrier from the antenna to the common port of the diplexer; ii) the high pass filter of the diplexer coupling the modulated carrier from the common port to the high pass port of the diplexer; iii) a coupling of the modulated carrier from the high pass port of the diplexer to the common port of the duplexer; iv) the high band pass filter of the duplexer passing the modulated carrier from the common port of the duplexer to a receive port of the duplexer; and v) a coupling for the modulated carrier from the receive port of the duplexer to the low noise amplifier receiving port of the transceiver.

In one embodiment, the coupling of the first band modulated carrier from the first transmitter port of the transceiver to the low pass port of the diplexer comprises: i) a coupling of the first band modulated carrier from the first transmitter port of the transceiver to an input port of a first SAW filter; ii) a coupling of the first band modulated carrier from an output port of the first SAW filter to an input port of a first band power amplifier; and iii) a coupling of the first band modulated carrier from an output port of the first band power amplifier to the low pass port of the diplexer.

In another embodiment, the coupling of the first band modulated carrier from the first transmitter port of the transceiver to the low pass port of the diplexer comprises: i) a coupling of the first band modulated carrier from the first transmitter port of the transceiver to an input port of a first SAW filter; ii) a coupling of the first band modulated carrier from an output port of the first SAW filter to an input port of a first band power amplifier; iii) a coupling of the first band modulated carrier from an output port of the first band power amplifier to an input port of a second SAW filter; and iv) a coupling of the first band modulated carrier from an output port of the second SAW filter to the low pass port of the diplexer.

The low pass filter of the diplexer is configured to pass a frequency band between 1,710 MHz and 1,755 MHz. The high pass filter of the diplexer is configured to pass a frequency band between 1,920 MHz and 2,179 MHz. The low band pass filter of the duplexer is configured to pass a frequency band between 1,920 MHz and 1,980 MHz, And, the high band pass filter of the duplexer is configured to pass a frequency band between 2,110 MHz and 2,170 MHz.

A third aspect of the present invention comprises a portable electronic device comprising a multi-band wireless transceiver for communication with a remote device. The portable electronic device comprises a transceiver, an antenna, and a front-end circuit coupled between the transceiver and the antenna.

The transceiver: i) generates a first band modulated carrier at a first transmitter port; ii) generates a second band modulated carrier at a second transmitter port; and iii) includes a low noise amplifier receiving port.

The front-end circuit comprises a first band modulated carrier transmission signal path from a first transmitter port of a transceiver to an antenna. The first modulated carrier transmission signal path comprises: i) a coupling of a first band modulated carrier from the first transmitter port of the transceiver to a low pass port of a diplexer; ii) the diplexer comprising a low pass filter coupling the first band modulated carrier from the low pass port of the diplexer to a common port of the diplexer; and iii) a coupling of the first band modulated carrier from the common port of the diplexer to the antenna.

The front-end circuit further comprises a second band modulated carrier transmission signal path from a second transmitter port of the transceiver to the antenna. The second band modulated carrier transmission signal path comprises: i) a coupling of the second band modulated carrier from the second transmitter port of the transceiver to a transmit port of a duplexer; ii) the duplexer comprising a low band pass filter coupling the second band modulated carrier from the transmit port of the duplexer to a common port of the duplexer (while isolating the second band modulated carrier from a receive port of the duplexer); iii) a coupling of the second band modulated carrier from the common port of the duplexer to a high pass port of the diplexer; iv) the diplexer comprising a high pass filter coupling the second band modulated carrier from the high pass port of the diplexer to the common port of the diplexer; and v) a coupling of the second band modulated carrier from the common port of the diplexer to the antenna.

The front-end circuit further comprises a modulated carrier received signal path from the antenna to a low noise amplifier receiving port of the transceiver. The modulated carrier received signal path comprises: i) a coupling of a modulated carrier from the antenna to the common port of the diplexer; ii) the high pass filter of the diplexer coupling the modulated carrier from the common port to the high pass port of the diplexer; iii) a coupling of the modulated carrier from the high pass port of the diplexer to the common port of the duplexer; iv) the high band pass filter of the duplexer passing the modulated carrier from the common port of the duplexer to a receive port of the duplexer; and v) a coupling for the modulated carrier from the receive port of the duplexer to the low noise amplifier receiving port of the transceiver.

Again, in one embodiment, the coupling of the first band modulated carrier from the first transmitter port of the transceiver to the low pass port of the diplexer comprises: i) a coupling of the first band modulated carrier from the first transmitter port of the transceiver to an input port of a first SAW filter; ii) a coupling of the first band modulated carrier from an output port of the first SAW filter to an input port of a first band power amplifier; and iii) a coupling of the first band modulated carrier from an output port of the first band power amplifier to the low pass port of the diplexer.

Again, in another embodiment, the coupling of the first band modulated carrier from the first transmitter port of the transceiver to the low pass port of the diplexer comprises: i) a coupling of the first band modulated carrier from the first transmitter port of the transceiver to an input port of a first SAW filter; ii) a coupling of the first band modulated carrier from an output port of the first SAW filter to an input port of a first band power amplifier; iii) a coupling of the first band modulated carrier from an output port of the first band power amplifier to an input port of a second SAW filter; and iv) a coupling of the first band modulated carrier from an output port of the second SAW filter to the low pass port of the diplexer.

Again, the low pass filter of the diplexer is configured to pass a frequency band between 1,710 MHz and 1,755 MHz. The high pass filter of the diplexer is configured to pass a frequency band between 1,920 MHz and 2,179 MHz. The low band pass filter of the duplexer is configured to pass a frequency band between 1,920 MHz and 1,980 MHz, And, the high band pass filter of the duplexer is configured to pass a frequency band between 2,110 MHz and 2,170 MHz.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a triplexer circuit;

FIG. 2 is a diagram representing an exemplary mobile device in accordance with one embodiment of the present invention; and

FIG. 3 depicts an exemplary front end circuit coupling a multi-band transceiver to an antenna in accordance with one exemplary embodiment of the present invention.

### DETAILED DESCRIPTION OF EMBODIMENTS

The term “electronic equipment” as referred to herein includes portable radio communication equipment. The term “portable radio communication equipment”, also referred to herein as a “mobile radio terminal” or “mobile device”, includes all equipment such as mobile phones, pagers, communicators, e.g., electronic organizers, personal digital assistants (PDAs), smart phones or the like.

Many of the elements discussed in this specification, whether referred to as a “system” a “module” a “circuit” or similar, may be implemented in hardware circuit(s), a processor executing software code, or a combination of a hardware circuit and a processor executing code. As such, the term circuit as used throughout this specification is intended to encompass a hardware circuit (whether discrete elements or an integrated circuit block), a processor executing code, or a combination of a hardware circuit and a processor executing code, or other combinations of the above known to those skilled in the art.

In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

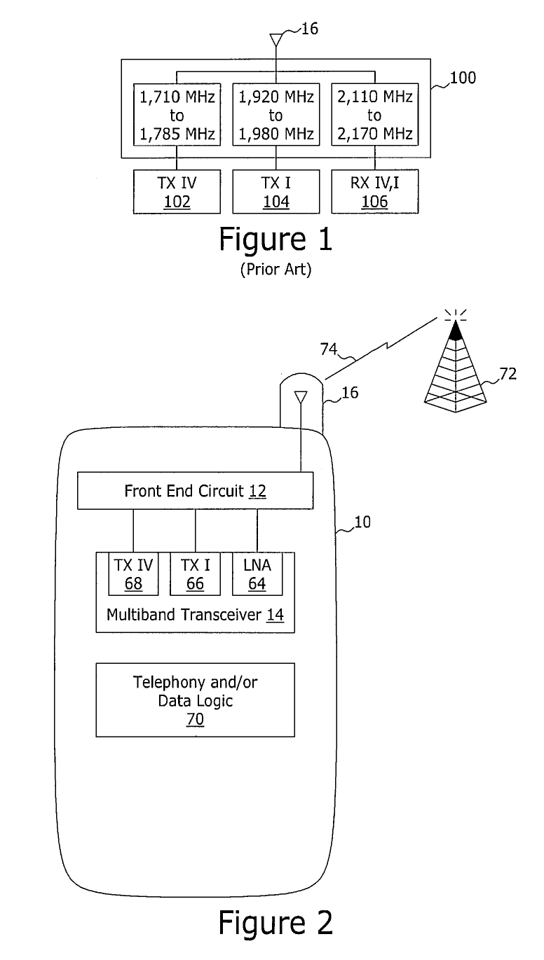

With reference to FIG. 1, mobile device 10 may be a portable radio communication equipment such as a mobile telephone, PDA, or other mobile device capable of operating within a network service provider's wide area network (service provider network) via wireless communication 74 with a remote device such as an access point 72 of the service provider network.

The mobile device 10 may comprise telephony or data logic 70 for implementing the mobile telephone functions, the PDA functions, or other functions applicable to the mobile device 10. A multi-band transceiver 14 operates in at least Universal Mobile Telecommunication System (UMTS) Band I and Band IV. The multi-band transceiver includes a Band IV transmit port 68 at which a modulated carrier within the UMTS Band IV transmit frequency band (e.g. 1,710 MHz to 1,755 MHz) is generated; a Band I transmit port 66 at which a modulated carrier within the UMTS Band I transmit frequency band (1,920 MHz to 1,980 MHz) is generated; and a low noise amplifier port 64 configured for receiving a modulated carrier within the overlapping UMTS Band I and UMTS Band IV receive frequency band (2,110 MHz to 2,170 MHz).

A front end circuit 12 couples each of the Band IV transmit port 68, the Band I transmit port 66, and the LNA receiving port 64 to a common antenna 16 for communication with another device such as the access point 72.

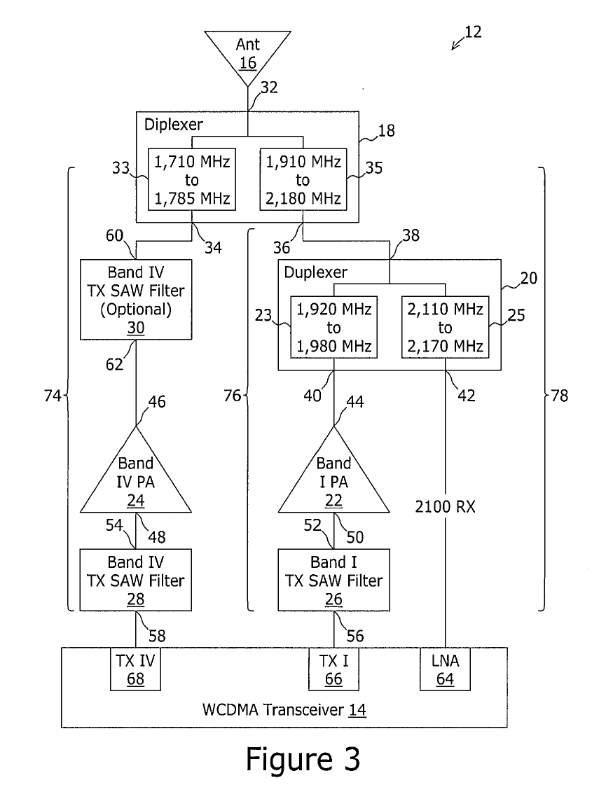

Turning to FIG. 3, the exemplary front end circuit 12 coupled between the antenna 16 and the transceiver 14 may comprise a diplexer 18, an duplexer 20, a Band I power amplifier 22, a Band IV power amplifier 24, a Band I filter 26, a first Band IV filter 28 and, optionally, a second Band IV filter 30.

The diplexer 18 comprises a common port 32 and a low pass filter 33 that couples the common port 32 to a lower band port 34. In addition, the diplexer includes a high pass filter 35 that couples the common port 32 to an upper band port 36. The low pass filter of the diplexer 18 is configured to pass a lower frequency band of approximately 1,710 MHz to 1,785 MHz. The high pass filter of the diplexer 18 is configured to pass an upper frequency band of approximately 1,920 MHz to 2,180 MHz.

The common port 32 is coupled to the antenna 16. The lower band port 34 (the low pass filter side of the diplexer 18) coupled to an output port 60 of the second Band IV filter 30 (or if the second Band IV filter 30 is not used, coupled to an output port of the Band IV power amplifier 24). The upper band port 36 (the high pass filter side of the diplexer 18) is coupled to a common port 38 of the duplexer 20.

The duplexer 20 comprises the common port 38 coupled to the upper band port 36 of the diplexer 18. A low band pass filter 23 couples the common port 38 to a transmit port 40 (e.g. the transmit side of the duplexer 20). A high band pass filter 25 couples the common port 38 to a receive port 42 (e.g. the receive side of the duplexer 20) while attenuating a transmit signal at the receive port 42.

The transmit port 40 is coupled to an output 44 port of the Band I power amplifier 22. The receiver port 42 is coupled to the low noise amplifier (LNA) receiver port 64 of the transceiver 14.

In the exemplary embodiment, the high band pass filter passes a frequency band between 2,110 MHz and 2,170 MHz to support receiving UMTS Band I at 2,110 MHz to 2,170 MHz and receiving UMTS Band IV at 2,110 MHz to 2,155 MHz.

The UMTS Band I transmit port 66 of the transceiver (1,920 MHz to 1,980 MHz) is coupled to an input port 56 the Band I filter 26. The Band I filter 26 may be a surface acoustic wave (SAW) filter passing the UMTS Band I transmit frequency band (e.g. 1,920 MHz to 1,980 MHz). Its output port 52 is coupled to an input port of the Band I power amplifier 22. The Band I power amplifier 22 receives the transmit signal from the Band I filter 26 and includes an output port 44 coupled to the transmit port 40 of the duplexer 20.

The UMTS Band IV transmit port 68 of the transceiver 14 is coupled to an input port 58 the first Band IV filter 28. The first Band IV filter 28 may be a surface acoustic wave filter passing the UMTS Band IV transmit frequency band (e.g. 1,710 MHz to 1,755 MHz). Its output port 54 is coupled to an input port of the Band IV power amplifier 24. The Band IV power amplifier 24 receives the transmit signal from the first Band IV filter 28 and includes an output port 46 coupled to an input port of the second Band IV filter 30 or, if a second Band IV filter 30 is not used, to the lower band port 34 of the diplexer 18.

If the optional second Band IV filter 30 is used, it may be a SAW filter passing in the UMTS Band IV transmit frequency band and its output port may be coupled to the lower band port 34 of the diplexer 18. The purpose of the second Band IV filter 30 is to provide, in addition to TX-RX attenuation provided by the diplexer 18, additional Band IV TX-RX attenuation. More specifically, by suppressing out-of-band noise, the second Band IV filter 30 reduces the attenuation requirements of the diplexer 18 that would otherwise be needed to prevent the Band IV transmission signal on the low pass side of the diplexer from interfering with a received signal on the high pass side of the diplexer 18.

In operation, when communicating with another device using UMTS Band I, the modulated carrier signal generated at the Band I transmit port 66 is coupled to the antenna 16 along a Band I transmission signal path 76. More specifically, the Band I modulated carrier signal generated by the transceiver 14 is coupled from the UMTS Band I transmit port 66 to the input port 56 of the Band I filter 26 for purposes of suppressing out-of-band noise. The modulated carrier signal at the output port 52 of the Band I filter is amplified by the Band I power amplifier 22 and coupled to the transmit port 40 of the duplexer 20. The low band pass filter 23 of the duplexer 20 couples the carrier signal to the upper band port 36 of the diplexer 18 and the high pass filter 35 of the diplexer 18 couples the Band I carrier signal to the antenna 16.

In operation, when communicating with a tower utilizing UMTS Band 1V, the modulated carrier signal generated at the Band IV transmit port 68 is coupled to the antenna 16 along a Band IV transmission signal path 74. More specifically, the Band IV modulated carrier signal generated by the transceiver 14 is coupled from the UMTS Band IV transmit port 68 to the input port 58 of the first Band IV filter 28 for purposes of suppressing out-of-band noise. The modulated carrier signal at the output port 54 of the first Band IV filter 28 is amplified by the Band IV power amplifier 24 and, if a second Band IV filter 30 is not used, is coupled to the lower band port 34 of the diplexer 18 and the low pass filter 33 of the diplexer 18 couples the Band IV carrier signal to the antenna 16.

When communicating using either Band I or Band IV, the electromagnetic wave of remote carrier signal imparted on the antenna 16 (within frequency band 2,110 MHz to 2,170 MHz) is passed to the LNA receiving port 64 along a received signal path 78. More specifically, the high pass filter 35 of the diplexer 19 passes the carrier to the common port 38 of the duplexer 20. The high band pass filter 25 of the duplexer couples the carrier to the Bands I and IV LNA receiving port 64 of the transceiver 14.

It should be appreciated that the front end circuit 12 facilitates implementation of a dual band transceiver operating in both UMTS Band I and UMTS Band IV without requiring use of a triplexer with two transmit ports (utilizing distinct frequency bands) and a single receiving port—also distinct from both transmitting frequency bands.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A front-end circuit for a multi-band wireless transceiver, the front-end circuit comprising:
a diplexer comprising:
a common port to be coupled to an antenna;
a lower band port coupled to the common port by a low pass filter;
an upper band port coupled to the common port by a high pass filter; and
the diplexer for receiving, at the lower band port, a first band modulated carrier from a first transmitter port of the transceiver;
a duplexer including:
a common port coupled to the upper band port of the diplexer;
a transmit port coupled to the common port by a low band pass filter;
a receive port coupled to the common port by a high band pass filter and to be coupled to a receiving port of the transceiver; and
the duplexer for receiving, at the transmit port, a second band modulated carrier from a second transmitter port of the transceiver.

2. The front-end circuit of claim 1, wherein:
the low pass filter of the diplexer is configured to pass a frequency band between 1,710 MHz and 1,755 MHz;
the high pass filter of the diplexer is configured to pass a frequency band between 1,920 MHz and 2,179 MHz;
the low band pass filter of the duplexer is configured to pass a frequency band between 1,920 MHz and 1,980 MHz; and
the high band pass filter of the duplexer is configured to pass a frequency band between 2,110 MHz and 2,170 MHz.

3. The front-end circuit of claim 1, further comprising:
a first surface acoustic wave filter with an input to be coupled to the first transmitter port of the transceiver and an output coupled to an input port of a lower band power amplifier; and
the lower band power amplifier including an output port coupled to the lower band port of the diplexer such that the first band modulated carrier is coupled from the first transmitter port of the receiver to the lower band port of the diplexer through the first surface acoustic wave filter and the power amplifier.

4. The front-end circuit of claim 3, wherein:
the low pass filter of the diplexer is configured to pass a frequency band between 1,710 MHz and 1,755 MHz;
the high pass filter of the diplexer is configured to pass a frequency band between 1,920 MHz and 2,179 MHz;
the low band pass filter of the duplexer is configured to pass a frequency band between 1,920 MHz and 1,980 MHz; and
the high band pass filter of the duplexer is configured to pass a frequency band between 2,110 MHz and 2,170 MHz.

5. The front-end circuit of claim 1, further comprising:
a first surface acoustic wave filter with an input to be coupled to the first transmitter port of the transceiver and an output coupled to an input port of a lower band power amplifier;
the lower band power amplifier including an output port coupled to an input port of a second surface acoustic wave filter; and
the second acoustic wave filter including an output port coupled to the lower band port of the diplexer such that the first band modulated carrier is coupled from the first transmitter port of the receiver to the lower band port of the diplexer through the first surface acoustic wave filter, the power amplifier, and the second acoustic wave filter.

6. The front-end circuit of claim 5, wherein:
the low pass filter of the diplexer is configured to pass a frequency band between 1,710 MHz and 1,755 MHz;
the high pass filter of the diplexer is configured to pass a frequency band between 1,920 MHz and 2,179 MHz;
the low band pass filter of the duplexer is configured to pass a frequency band between 1,920 MHz and 1,980 MHz; and
the high band pass filter of the duplexer is configured to pass a frequency band between 2,110 MHz and 2,170 MHz.

7. A front-end circuit for a multi-band wireless receiver, the front-end circuit comprising:
a first band modulated carrier transmission signal path from a first transmitter port of a transceiver to an antenna, the first modulated carrier transmission signal path comprising:
a coupling of a first band modulated carrier from the first transmitter port of the transceiver to a low pass port of a diplexer;
the diplexer comprising a low pass filter coupling the first band modulated carrier from the low pass port of the diplexer to a common port of the diplexer; and
a coupling of the first band modulated carrier from the common port of the diplexer to the antenna;
a second band modulated carrier transmission signal path from a second transmitter port of the transceiver to the antenna, the second band modulated carrier transmission signal path comprising:
a coupling of the second band modulated carrier from the second transmitter port of the transceiver to a transmit port of a duplexer;
the duplexer comprising a low band pass filter coupling the second band modulated carrier from the transmit port of the duplexer to a common port of the duplexer;
a coupling of the second band modulated carrier from the common port of the duplexer to a high pass port of the diplexer
the diplexer comprising a high pass filter coupling the second band modulated carrier from the high pass port of the diplexer to the common port of the diplexer; and
a coupling of the second band modulated carrier from the common port of the diplexer to the antenna; and
a modulated carrier received signal path from the antenna to a receiving port of the transceiver, the modulated carrier received signal path comprising:
a coupling of a modulated carrier from the antenna to the common port of the diplexer;
the high pass filter of the diplexer coupling the modulated carrier from the common port to the high pass port of the diplexer;
a coupling of the modulated carrier from the high pass port of the diplexer to the common port of the duplexer;
the duplexer comprising a high band pass filter coupling the modulated carrier from the common port of the duplexer to a receive port of the duplexer while attenuating the second band modulated carrier; and
a coupling for the modulated carrier from the receive port of the duplexer to the receiving port of the transceiver.

8. The front-end circuit of claim 7, wherein:
the low pass filter of the diplexer is configured to pass a frequency band between 1,710 MHz and 1,755 MHz;
the high pass filter of the diplexer is configured to pass a frequency band between 1,920 MHz and 2,179 MHz;
the low band pass filter of the duplexer is configured to pass a frequency band between 1,920 MHz and 1,980 MHz; and
the high band pass filter of the duplexer is configured to pass a frequency band between 2,110 MHz and 2,170 MHz.

9. The front-end circuit of claim 7, wherein the coupling of a first band modulated carrier from the first transmitter port of the transceiver to a low pass port of a diplexer comprises:
a coupling of the first band modulated carrier from the first transmitter port of the transceiver to an input port of a first surface acoustic wave filter;
a coupling of the first band modulated carrier from an output port of the first surface acoustic wave filter to an input port of a first band power amplifier; and
a coupling of the first band modulated carrier from an output port of the first band power amplifier to the low pass port of the diplexer.

10. The front-end circuit of claim 9, wherein:
the low pass filter of the diplexer is configured to pass a frequency band between 1,710 MHz and 1,755 MHz;
the high pass filter of the diplexer is configured to pass a frequency band between 1,920 MHz and 2,179 MHz;
the low band pass filter of the duplexer is configured to pass a frequency band between 1,920 MHz and 1,980 MHz; and
the high band pass filter of the duplexer is configured to pass a frequency band between 2,110 MHz and 2,170 MHz.

11. The front-end circuit of claim 7, wherein the coupling of a first band modulated carrier from the first transmitter port of the transceiver to a low pass port of a diplexer comprises:
a coupling of the first band modulated carrier from the first transmitter port of the transceiver to an input port of a first surface acoustic wave filter;
a coupling of the first band modulated carrier from an output port of the first surface acoustic wave filter to an input port of a first band power amplifier;
a coupling of the first band modulated carrier from an output port of the first band power amplifier to an input port of a second acoustic wave filter; and
a coupling of the first band modulated carrier from an output port of the second surface acoustic wave filter to the low pass port of the diplexer.

12. The front-end circuit of claim 11, wherein:
the low pass filter of the diplexer is configured to pass a frequency band between 1,710 MHz and 1,755 MHz;
the high pass filter of the diplexer is configured to pass a frequency band between 1,920 MHz and 2,179 MHz;
the low band pass filter of the duplexer is configured to pass a frequency band between 1,920 MHz and 1,980 MHz; and
the high band pass filter of the duplexer is configured to pass a frequency band between 2,110 MHz and 2,170 MHz.

13. A portable electronic device comprising a multi-band wireless transceiver for communication with a remote device, the portable electronic device comprising:
a transceiver, the transceiver:
generating a first band modulated carrier at a first transmitter port;
generating a second band modulated carrier at a second transmitter port; and
including a low noise amplifier receiving port;
an antenna; and
a front end circuit coupled between the transceiver and the antenna, the front end circuit comprising:
a first band modulated carrier transmission signal path from the first transmitter port of the transceiver to the antenna, the first modulated carrier transmission signal path comprising:
a coupling of a first band modulated carrier from the first transmitter port of the transceiver to a low pass port of a diplexer;
the diplexer comprising a low pass filter coupling the first band modulated carrier from the low pass port of the diplexer to a common port of the diplexer; and
a coupling of the first band modulated carrier from the common port of the diplexer to the antenna;
a second band modulated carrier transmission signal path from a second transmitter port of the transceiver to the antenna, the second band modulated carrier transmission signal path comprising:
a coupling of the second band modulated carrier from the second transmitter port of the transceiver to a transmit port of a duplexer;
the duplexer comprising a low band pass filter coupling the second band modulated carrier from the transmit port of the duplexer to a common port of the duplexer;
a coupling of the second band modulated carrier from the common port of the duplexer to a high pass port of the diplexer
the diplexer comprising a high pass filter coupling the second band modulated carrier from the high pass port of the diplexer to the common port of the diplexer; and
a coupling of the second band modulated carrier from the common port of the diplexer to the antenna; and
a modulated carrier received signal path from the antenna to a receiving port of the transceiver, the modulated carrier received signal path comprising
a coupling of a modulated carrier from the antenna to the common port of the diplexer;
the high pass filter of the diplexer coupling the modulated carrier from the common port to the high pass port of the diplexer;
a coupling of the modulated carrier from the high pass port of the diplexer to the common port of the duplexer;
the duplexer comprising a high band pass filter coupling the modulated carrier from the common port of the duplexer to a receive port of the duplexer while attenuating the second band modulated carrier; and
a coupling for the modulated carrier from the receive port of the duplexer to the receiving port of the transceiver.

14. The front-end circuit of claim 13, wherein:
the low pass filter of the diplexer is configured to pass a frequency band between 1,710 MHz and 1,755 MHz;
the high pass filter of the diplexer is configured to pass a frequency band between 1,920 MHz and 2,179 MHz;
the low band pass filter of the duplexer is configured to pass a frequency band between 1,920 MHz and 1,980 MHz; and
the high and pass filter of the duplexer is configured to pass a frequency band between 2,110 MHz and 2,170 MHz.

15. The front-end circuit of claim 13, wherein the coupling of a first band modulated carrier from the first transmitter port of the transceiver to a low pass port of a diplexer comprises:
a coupling of the first band modulated carrier from the first transmitter port of the transceiver to an input port of a first surface acoustic wave filter;
a coupling of the first band modulated carrier from an output port of the first surface acoustic wave filter to an input port of a first band power amplifier; and
a coupling of the first band modulated carrier from an output port of the first band power amplifier to the low pass port of the diplexer.

16. The front-end circuit of claim 15, wherein:
the low pass filter of the diplexer is configured to pass a frequency band between 1,710 MHz and 1,755 MHz;
the high pass filter of the diplexer is configured to pass a frequency band between 1,920 MHz and 2,179 MHz;
the low band pass filter of the duplexer is configured to pass a frequency band between 1,920 MHz and 1,980 MHz; and
the high band pass filter of the duplexer is configured to pass a frequency band between 2,110 MHz and 2,170 MHz.

17. The front-end circuit of claim 13, wherein the coupling of a first band modulated carrier from the first transmitter port of the transceiver to a low pass port of a diplexer comprises:
a coupling of the first band modulated carrier from the first transmitter port of the transceiver to an input port of a first surface acoustic wave filter;
a coupling of the first band modulated carrier from an output port of the first surface acoustic wave filter to an input port of a first band power amplifier;
a coupling of the first band modulated carrier from an output port of the first band power amplifier to an input port of a second acoustic wave filter; and
a coupling of the first band modulated carrier from an output port of the second surface acoustic wave filter to the low pass port of the diplexer.

18. The front-end circuit of claim 17, wherein:
the low pass filter of the diplexer is configured to pass a frequency band between 1,710 MHz and 1,755 MHz;
the high pass filter of the diplexer is configured to pass a frequency band between 1,920 MHz and 2,179 MHz;
the low band pass filter of the duplexer is configured to pass a frequency band between 1,920 MHz and 1,980 MHz; and
the high band pass filter of the duplexer is configured to pass a frequency band between 2,110 MHz and 2,170 MHz.
